(19) United States
(12) Patent Application Publication
(10) Pub. No.: US 2005/0197027 A1
(43) Pub. Date: Sep. 8, 2005

(54) Bloused spunbond laminate

(75) Inventors: Patrick L. Crane, Dawsonville, GA (US); Martin A. Allen, Dawsonville, GA (US)

Correspondence Address: WOOD, HERRON & EVANS, LLP (NORDSON), 2700 CAREW TOWER, 441 VINE STREET, CINCINNATI, OH, 45202, US

(73) Assignee: Nordson Corporation, Westlake, OH (US)

(21) Appl. No.: 10/793,395

(22) Filed: Mar. 4, 2004

(51) Int. Cl. B32B 5/26; D04H 3/16

(52) U.S. Cl. 442/382; 442/401; 442/389; 156/167

(57) ABSTRACT

A multi-ply laminate formed from at least two laminated nonwoven webs. One of the nonwoven webs is formed from filaments meltspun at a spinning speed insufficient to return the crystallinity of the constituent polymer to the crystallinity before conversion to a molten state for meltspinning, which makes these filaments prone to shrinkage when heated. Other nonwoven web(s) in the laminate are formed from filaments characterized by a substantially recrystallized polymer. The laminate is heated to a temperature sufficient to cause contraction of filaments in the non-woven web of deficient crystallinity. The shrinkage reduces the surface area of the non-crystallized web relative to the surface area of the crystallized web(s), which have substantial dimensional stability. This results in blousing manifested by raised areas that increases the loft and improves other properties of the multi-ply laminate.

### FIELD OF THE INVENTION

The invention relates generally to melt-spinning methods and products, and more particularly to methods of forming high-loft nonwoven webs from multi-component filaments and high-loft nonwoven webs formed by such methods.

### BACKGROUND OF THE INVENTION

Spunbond nonwoven webs formed by meltspinning processes are incorporated into multiple different consumer and industrial products, such as single-use or short-life hygienic articles, disposable protective apparel like surgical gowns, surgical masks and surgical drapes, and durables like bedding and carpeting. Spunbond nonwoven webs have a physical structure of individual filaments that are airlaid in entangled arrangement, but not in a regular, identifiable manner as is characteristic of a knitted or woven fabric.

Spunbond filaments are typically continuous and produced from one or more thermoplastic polymers. The filaments are generally oriented as loops in the X-Y plane of the spunbond nonwoven web, which is relatively thin. The thickness or loft of a spunbond nonwoven web influences many surface characteristics of the nonwoven web, such as drape, hand, texture and insulation. Nonwoven webs in consumer products have been perceived as being overly stiff to the touch and to lack the softness of a woven or knitted fabric, which is important in applications where the nonwoven web contacts the wearer's skin or the skin of an adjacent person. The hand of a nonwoven web may play an important role in a decision by a consumer to purchase one or another product. Therefore, significant efforts have been expended by manufacturers to improve the loft and surface characteristics of spunbond nonwoven webs.

Post-production treatments, such as brushing, stretch/recovery, and other mechanical operations including creping or pleating, have been applied to enhance the loft of a spunbond nonwoven web. One conventional post-production treatment chops the melt spun filaments to produce short fibers, which are then carded and bonded with a chemical agent or a heat agent. Such conventional post-production treatments must be performed by an apparatus separately from the meltspinning production line and increases the production cost.

For these reasons, it is desirable to provide a method of producing spunbonded nonwoven webs having improved loft and surface characteristics without post-production treatments and, furthermore, to provide nonwoven webs produced by this method.

### SUMMARY

The present invention addresses these and other problems associated with the prior art by providing a spunbond nonwoven web having more cloth-like aesthetics without resorting to post-production treatments. Specifically, a spunbond laminate in accordance with the principles of the invention includes a first nonwoven web including spunbond filaments of a first thermoplastic polymer and a second nonwoven web including spunbond filaments of a second thermoplastic polymer. The first thermoplastic polymer is characterized by a spun crystallinity that is substantially equal to its initial crystallinity in a solid state before spinning to form spunbond filaments. The second thermoplastic polymer is characterized by a spun crystallinity that is substantially less than its initial crystallinity in a solid state before spinning to form spunbond filaments. The first nonwoven web is bonded to the second nonwoven layer at a plurality of bonded areas. The first nonwoven layer includes a plurality of raised areas each bounded by, or between, bonded areas. The raised areas are produced by causing the spun crystallinity of the second thermoplastic polymer to approach the initial crystallinity of the second thermoplastic polymer, after the second plurality of filaments are formed, and thereby shrinking the second nonwoven web relative to the first nonwoven web.

In another aspect, a method of forming a bloused laminate includes forming a first plurality of filaments from a molten first thermoplastic polymer characterized by an initial solid-state crystallinity, attenuating these filaments at a spinning speed effective to cause the first thermoplastic polymer to have a spun crystallinity approximately equal to the initial solid-state crystallinity, and collecting these filaments to form a first nonwoven web. A second plurality of filaments are formed from a molten second thermoplastic polymer characterized by an initial solid-state crystallinity, attenuated at a spinning speed effective to cause the second thermoplastic polymer to have a spun crystallinity less than the initial solid-state crystallinity, and collected as a second nonwoven web. The first and second nonwoven webs are bonded at a plurality of bonded areas and then heated to cause the spun crystallinity of the second thermoplastic polymer to approach its initial solid-state crystallinity. This induces a surface area of the second nonwoven web to shrink relative to a surface area of the first nonwoven web and thereby form a plurality of raised areas in the first nonwoven layer each bounded by bonded areas.

These and other objects and advantages of the present invention shall become more apparent from the accompanying drawings and description thereof.

### BRIEF DESCRIPTION OF THE FIGURES

The accompanying drawings, which are incorporated in and constitute a part of this specification, illustrate embodiments of the invention and, together with a general description of the invention given above, and the detailed description given below, serve to explain the principles of the invention.

FIG. 1 is a perspective view of a multiple-station production line for producing the nonwoven webs of the invention;

FIG. 2 is a cross-sectional view of the filament-drawing device of FIG. 1;

FIG. 3 is a diagrammatic side view of a multiply spunbond laminate in accordance with the principles of the invention before being in-line processed;

FIG. 4A is a diagrammatic side view similar to FIG. 3 of the multiply spunbond laminate after being in-line processed to trigger shrinkage of the middle spunbond nonwoven web relative to the outer spunbond nonwoven webs;

FIG. 4B is a top view of the multi-ply spunbond laminate of FIG. 3;

FIG. 4C is a diagrammatic side view similar to FIG. 4A in which the multi-ply laminate includes only two spunbond layers;

FIG. 5 is a perspective view of a heated bonder suitable for use with the multiple-station production line of FIG. 1 for producing the nonwoven webs of the invention; and

FIG. 6 is a perspective view of another heated bonder suitable for use with the multiple-station production line of FIG. 1 for producing the nonwoven webs of the invention.

### DETAILED DESCRIPTION OF THE PREFERRED EMBODIMENTS

The invention is directed to a multi-ply laminate of spunbond nonwoven webs having loft and surface characteristics that closely mimic the loft and surface characteristics of woven or knitted fabrics. Although the invention will be described herein as being associated with an exemplary meltspinning system, it should be understood that modifications to the exemplary meltspinning system described herein could be made without departing from the intended spirit and scope of the invention.

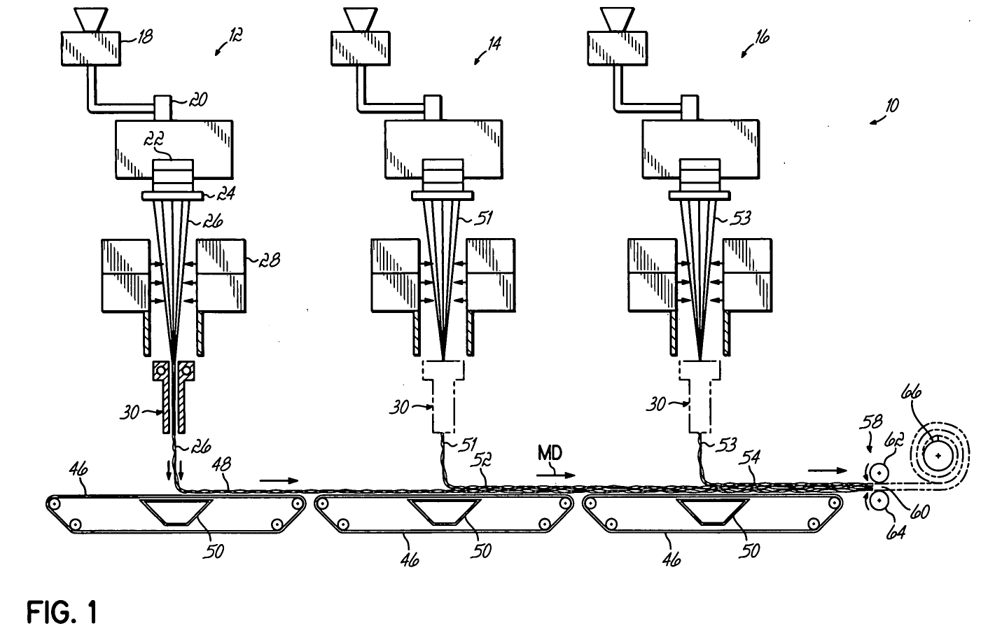

With reference to FIG. 1, a multiple-station production line, generally indicated by reference numeral 10, includes three spunbonding stations 12, 14, and 16 each capable of forming a spunbond nonwoven web. As the spunbonding stations 12, 14 and 16 are identical, the following discussion of spunbonding station 12 is equally applicable to spunbonding stations 14 and 16. The invention contemplates that additional stations may be present in the production line, such as a meltblowing station or additional spunbonding stations.

Spunbonding station 12 includes a screw extruder 18 that converts a solid melt-processable thermoplastic polymer into a flowable molten state and transfers the molten thermoplastic polymer under pressure to a metering pump 20. The metering pump 20 pumps discrete amounts of the corresponding thermoplastic polymer to a spin pack 22. Spin packs are known to persons of ordinary skill in the art and, therefore, are not described here in detail. Generally, spin pack 22 includes flow passageways arranged to direct the thermoplastic polymer to a spinneret 24 from which the thermoplastic polymer is discharged at an extrusion temperature of about 175° C. to about 300° C. from rows of spinning orifices (not shown) as a dense curtain of filaments 26. The shape of the spinning orifices in spinneret 24 may be selected to accommodate the cross-section desired for the filaments 26. The spunbonding station 12 may include one or more additional extruders 18 and metering pumps 20 for providing additional thermoplastic polymers to the spin pack 22, which would be configured with flow passageways to combine the thermoplastic polymers to form multi-component filaments. A quench blower 28 supplies a cross-flow of cooling air that quenches the filaments 26 exiting spinneret 24 to hasten solidification of the constituent thermoplastic polymers.

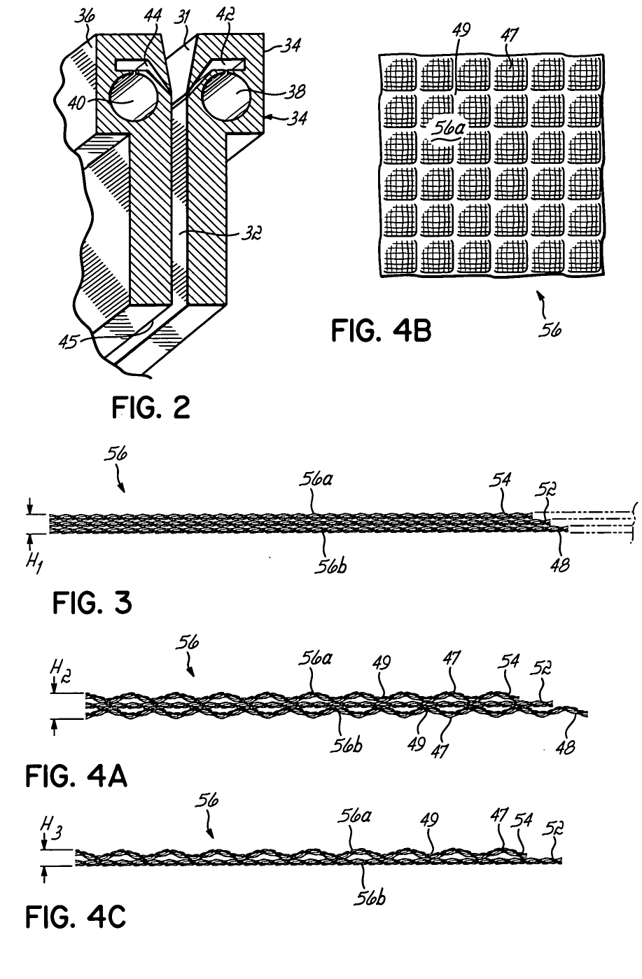

With reference to FIGS. 1 and 2, a filament-drawing device 30 receives the filaments 26 in a flared inlet 31 of a vertical slot 32 between upstream and downstream manifolds 34, 36. Process air supplied from a blower (not shown) is directed through air supply passageways 38, 40 inside the upstream and downstream manifolds 34, 36, respectively. Typically, the process air is supplied at a pressure of about 5 pounds per square inch (psi) to about 100 psi, typically within the range of about 30 psi to about 60 psi, and at a temperature of about 15° C. to about 30° C. The air supply passageways 38, 40 communicate with the vertical slot 32 through a corresponding one of slotted channels 42, 44. Each of the slotted channels 42, 44 tapers or narrows in a direction from the corresponding one of the air supply passageways 38, 40 to the vertical slot 32 for increasing the air velocity by the venturi effect. High velocity sheets of process air are exhausted continuously from the slotted channels 42, 44 along the opposite sides of the vertical slot 32 in a downwardly direction generally parallel to the length of the filaments 26. Because the filaments 26 are extensible, the converging, downwardly-directed sheets of high-velocity process air apply a downward air drag that attenuates and molecularly orients the filaments 26. The air pressure and characteristics of the slotted channels 42, 44 determine, to a great extent, the spinning speed of the filaments 26.

The invention contemplates that a variety of filament drawing devices may be used for attenuating and molecularly orienting filaments. Other exemplary filament-drawing devices suitable for use in the invention are disclosed in U.S. patent application Ser. No. 10/072,550, U.S. Pat. No. 4,340,563, and U.S. Pat. No. 6,182,732, the disclosures of which are hereby incorporated herein by reference in their entirety.

With reference to FIGS. 1 and 2, the descending curtain of filaments 26 is discharged from an outlet 45 of vertical slot 32 and propelled toward a porous collector 46, such as a moving screen belt. The filaments 26 deposit in a substantially random manner as flat loops on the collector 46 to collectively form an unbonded nonwoven web 48. The collector 46 moves in a machine direction, represented by the arrow labeled MD, parallel to the length of the nonwoven web 48. The collector 46 transports the nonwoven web 48 in the machine direction. An air management system 50 positioned beneath collector 46 in general vertical alignment with the vertical slot 32 supplies a vacuum transferred through the collector 46 for attracting the filaments 26 to the collector 46. Exemplary air management systems 50 are disclosed in U.S. Pat. No. 6,499,982, the disclosure of which is hereby incorporated by reference herein in its entirety.

Spunbonding station 14, in a manner similar to that described above, forms filaments 51 collected as a distinct unbonded nonwoven web 52 on nonwoven web 48. Similarly, spunbonding station 16, in a manner similar to that described above, forms filaments 53 collected as a distinct unbonded nonwoven web 54 on nonwoven web 52. The resulting trio of nonwoven webs 48, 52 and 54 constitutes a multi-ply laminate structure 56 of loosely consolidated and entangled layers of filaments 26, filaments 51, and filaments 53 that are autogenously bonded.

With reference to FIG. 3 and in accordance with the principles of the invention, the nonwoven webs 48 and 54 defining outermost layers of the laminate structure 56 are formed from filaments 26 and 53, respectively, that are not prone to shrinkage when heated or, at the least, prone to insignificant shrinkage when heated. In contrast, the nonwoven web 52 captured between nonwoven webs 48 and 54 is formed from filaments 51 that shrink significantly when heated to a suitable temperature. This difference in shrinkage properties is achieved by spinning the filaments 51 constituting nonwoven web 52 at a spinning speed in filament-drawing device 30 of spunbonding station 14 insufficient to return the constituent thermoplastic polymer of filaments 51 to the initial molecular orientation or crystallinity of the solid melt-processable polymer resin before conversion into a flowable molten state. The deficiency in the percentage of crystallinity provide filaments 51 with latent shrinkage that may be activated or triggered by heating. Different thermoplastic polymers have different spinning speeds for which orientation of the constituent molecular chains is realized. The degree of molecular alignment depends on the spinning speed, and the alignment of the polymer molecular chains constituting filaments 51 is related to the degree of polymer crystallization.

Before being converted from a solid melt-processable thermoplastic polymer into a flowable molten state by the screw extruder 18 of spunbonding station 14, the thermoplastic polymer constituting filaments 51 is characterized by a state with a percentage of crystalline material and a percentage of amorphous material. For example, one type of polyester resin is about 20 percent crystalline and 80 percent amorphous before being converted to the molten state, in which the polyester resin is 100 percent amorphous. Filaments 51 formed from the molten polyester resin have a lesser degree of crystallinity, as compared with the initial solid state before conversion to the molten state, after extrusion and spinning at a reduced spinning speed ineffective to reestablish the initial 20 percent crystallinity. For example, the polyester in filaments 51 may be characterized by 10 percent crystallinity after extrusion and spinning. When heated, the polyester constituting the filaments 51 returns to the initial state of 20 percent crystallinity before conversion or, at the least, the final crystallinity increases above the 10 percent crystallinity after spinning and collection as nonwoven web 52.

In contrast, filaments 26 and 53 are spun in filament drawing device 30 of spunbonding stations 12,16, respectively, such that the constituent thermoplastic polymers have a crystallinity similar or identical to their respective crystallinities in the solid state before conversion. As a result, nonwoven webs 48 and 54 are not prone to shrinkage when heated to a sufficient temperature to cause shrinkage of nonwoven web 52. As a result, the surface area (i.e., length and width) of nonwoven web 52 shrinks or contracts relative to the surface area of nonwoven webs 48 and 54 when the laminate structure 56 is heated. More specifically, nonwoven web 52 shrinks in the X and Y dimensions, which correspond to the planar length and width, respectively, of the laminate structure 56. Generally, the surface area of nonwoven web 52 shrinks about 10 percent to about 50 percent when the laminate structure 56 is heated to sufficient temperature and for an effective duration to produce the shrinkage. In contrast, nonwoven webs 48 and 54 experience an insignificant shrinkage at the temperature selected to shrink nonwoven web 52. In certain embodiments, the shrinkage of nonwoven webs 48 and 54 is less than 10 percent. The difference in area shrinkage between nonwoven webs 48 and 52 and nonwoven webs 52 and 54 determines the magnitude of the added loft or bulk, which is measured as an effective increase in a Z-dimension or thickness generally orthogonal to the X-Y dimensions.

In one specific embodiment of the invention, the filaments 26 of nonwoven web 48 and the filaments 53 of nonwoven web 54 are formed from polypropylene (PP), which is made from propylene monomer, and nonwoven web 52 comprises polyethylene terephthalate (PET). The polypropylene filaments 26 are oriented molecularly by operating the filament-drawing device 30 of spunbonding station 12 at a spinning speed of greater than or equal to about 3000 meters, which represents a spinning speed for polypropylene known to provide a crystallinity similar or identical to the crystallinity in the solid state before conversion. Similarly, the polypropylene filaments 53 of nonwoven web 54 are oriented molecularly by operating the filament-drawing device 30 of spunbonding station 16 at a spinning speed greater than or equal to about 3000 meters. The filament drawing device 30 of spunbonding station 14 is operated at a spinning speed less than about 4500 meters per minute. Spinning PET filaments 51 at spinning speeds of less than 4500 meters per minute does not return the constituent PET to its crystallinity in the solid state before conversion. For example, the filament drawing device 30 of spunbonding station 14 may be operated at a spinning speed of about 3500 meters per minute. The PET filaments 51 are highly susceptible to significant length shrinkage when heated because the PET is not returned to its initial crystallinity state due to the deficient spinning speed. As a result, the surface area of nonwoven web 52 shrinks relative to the surface area of nonwoven webs 48 and 54 when heated.

With continued reference to FIG. 3, the laminate structure 56 has a thickness, H₁, measured between the opposite substantially planar sides or surfaces 56a and 56b before heat is applied to trigger a real shrinkage or contraction of nonwoven web 52. The planar surfaces 56a, 56b contain slight irregularities so that minor deviations from planarity are present, but the laminate structure 56 is substantially free of irregularities of significant amplitude in the Z-dimension.

With renewed reference to FIG. 1, the laminate structure 56 is conveyed from collector 46 of spunbonding station 16 in the machine direction to a heated calender, generally indicated by reference numeral 58. The laminate structure 56 is passed under pressure through a nip 60 of a heated rotating patterned roll 62 and a rotating anvil roll 64 constituting the calender 58. The calender 58 bonds a fraction of the filaments 26, 51 and 53 of the nonwoven webs 48, 52 and 54, respectively, to each other at their contact points in a process known as thermal point bonding.

The surface of the patterned roll 62 is patterned with a discrete bond pattern of raised areas and relieved areas so that pressure is applied to significantly less than the entire surface area of laminate structure 56. Typically, the patterned roll 62 is patterned so that the bond area for thermal point bonding, represented by the raised pattern areas, is less than or equal to about 20 percent. This serves to limit any decrease in bulk or loft in the laminate structure 56 due to decreases in caliper but promotes heat transfer sufficient to trigger shrinkage of nonwoven web 52. The raised pattern features of the patterned roll 62 may be any suitable shape, such as oval mounds, truncated pyramids, or circular mounds, or may be defined by a grid of raised ribs or parallel raised ribs. Decreasing the bonding area operates to increase the loft increase from activating the latent shrinkage of nonwoven web 52.

The invention contemplates that the patterned roll 62 may include portions characterized by a bond area of less than or equal to 20 percent and other portions in which the bond area is greater than 20 percent. The resulting laminate structure 56 would have regions embossed by the low bond area portions susceptible to increased loft when heated and other regions embossed by the relatively-high bond area portions that are not susceptible to increased loft when heated.

The heat and pressure conditions, as well as the line speed at which the laminate structure 56 passes through the calender 58, are selected such that the surface area of the nonwoven web 52 shrinks relative to nonwoven webs 48, 54. Operating parameters such as temperature, line speed, and nip pressure may be determined and adjusted using techniques familiar to persons of ordinary skill in the art. Generally, the temperature of the nonwoven web 52 in the nip between patterned roll 62 and anvil roll 64 is in the range of about 100° C. to about 200° C., which is achieved by heating one or both of the rolls 62, 64. Finally, a winder 66 winds the laminate structure 56 into a roll.

With reference to FIGS. 4A and 4B, the laminate structure 56 will acquire a bloused appearance that imparts loftiness and surface texture after being heat treated by passage through the calender 58. Specifically, the latent shrinkage of nonwoven web 52 is activated by heat so that the surface area of nonwoven web 52 shrinks or contracts. Nonwoven webs 48, 54 remain dimensionally stable under heating and will retain their respective surface area dimensions. Nonwoven webs 48 and 52 and nonwoven webs 52 and 54 have numerous bond points created during forming in the multiple-station production line 10 so that voids are not produced during the shrinking process and relative sheet slippage is prevented. Instead, the laminate structure 56 acquires a series of shallow undulations or rounded-edge corrugations extending lengthwise and widthwise across the surface area of the laminate structure 56.

The undulations are characterized by an alternating pattern of raised areas 47 situated on both opposed surfaces 56a, 56b of the laminate structure 56 and bonded areas 49 characterized by a collective bond area of less than or equal to about 20% of the surface area of the laminate structure 56. As apparent, the surfaces 56a, 56b no longer have a planar appearance. The laminate structure 56 is characterized by an effective thickness, H₂, measured between a crest or apex of raised area 47 on opposed surface 56a and a crest or apex of raised area 47 on surface 56b. The effective thickness, h₂, is greater than the corresponding thickness h₁ before heating to trigger shrinkage of nonwoven web 52. Of course, the undulations giving rise to the effective thickness, h₂, are expected to have a statistical distribution of amplitudes so that the effective thickness, h₂, may be measured as either a maximum crest-to-crest Z-distance or as a statistically averaged crest-to-crest Z-distance.

The disparity in the dimensional change, as the respective X-Y areas of nonwoven webs 48, 54 do not shrink or shrink minimally, increases the loft or bulk of the laminate structure 56 in the Z-dimension and provides the bloused appearance. The raised areas 47 present on surfaces 56a, 56b of the laminate structure 56 increases the effective thickness of the laminate structure 56 measured orthogonal relative to a plane containing the length and width of the laminate structure 56, as described above. The increase in the loft or bulkiness improves the perceived softness of the laminate structure 56.

With reference to FIG. 4C, the invention contemplates that for example, nonwoven web 48 may be omitted from the multiply laminate structure 56. The laminate structure 56 would be formed in a production line (FIG. 1) including only spunbonding stations 14 and 16. As a result, the raised areas 47 are only manifested by nonwoven web 54 on one side of the laminate structure 56, after the latent shrinkage of nonwoven web 52 is triggered, so that the effective thickness, H₃, is increased relative to an initial lesser thickness. Alternatively, nonwoven web 54 may be omitted and nonwoven web 48 retained so that, the raised areas 47 are manifested by nonwoven web 48 as nonwoven web 52 shrinks. Under these circumstances, the laminate structure 56 would be formed in a production line (FIG. 1) including only spunbonding stations 12 and 14. The invention further contemplates that nonwoven webs 48 and 54 may be provided as preformed sheets of thermoplastic filaments having the requisite crystallization that are combined with nonwoven web 52, which is applied by spunbonding station 14 to pre-formed nonwoven web 48 and then laminated with pre-formed nonwoven web 54, to form laminate structure 56.

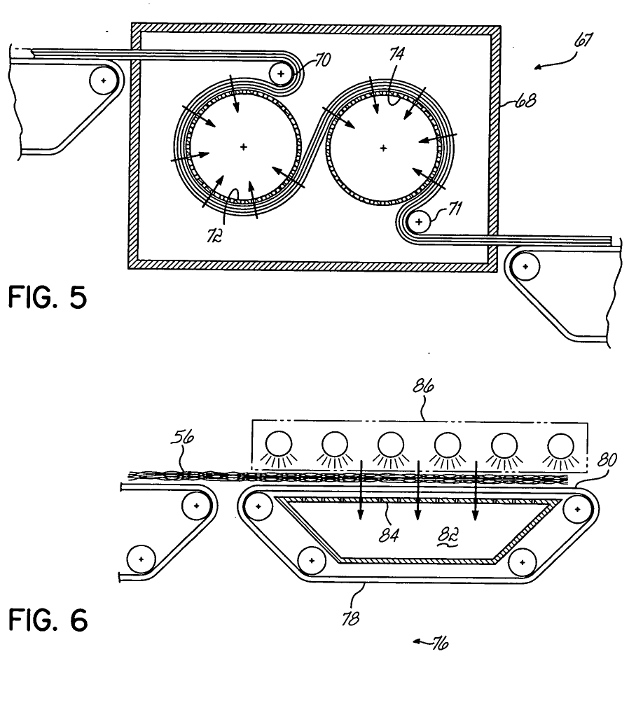

With reference to FIG. 5, a through-air bonder, generally indicated by reference numeral 67, is positioned after the calender 58 in production line 10. The laminate structure 56 is calendered by calender 58 at a temperature sufficient to bond a fraction of the filaments 26, 51 and 53 of the nonwoven webs 48, 52 and 54, respectively, by thermal point bonding but insufficient to either trigger shrinkage of nonwoven web 52 or to shrink the nonwoven web 52 by a level adequate to provide the desired raised areas 47 (FIGS. 4A and 4B). The laminate structure 56 is subsequently conveyed at a normal production line speed through the through-air bonder 67. The laminate structure 56 is conveyed into a heated oven or enclosure 68 of the through-air bonder 67 in which air sufficiently hot to cause nonwoven web 52 to shrink is forced through the laminate structure 56. Specifically, the air inside of enclosure 68 is heated to a temperature in the range of about 100° C. to about 200° C.

To increase the dwell time inside of heated enclosure 68, the path length is increased by moving the laminate structure 56 in a convoluted path about a cooperating set of guide rollers 70, 71 and set of perforated rollers 72, 74. Suction applied to the interior of each of the perforated rollers 72, 74 pulls heated air through the laminate structure 56 and perforations in the perforated rollers 72, 74, as indicated by the arrows in FIG. 5. Pulling the air through the laminate structure 56 with a forced flow promotes rapid and even transmission of heat to nonwoven web 52 and triggers shrinkage of nonwoven web 52 relative to surrounding nonwoven webs 48 and 54. The shrinkage may be additive with any shrinkage during calendering.

With reference to FIG. 6, a through-air bonder, generally indicated by reference numeral 76, may be substituted for through-air bonder 67 in production line 10. Typically, the laminate structure 56 is calendered by calender 58 at a temperature sufficient to bond a fraction of the filaments 26, 51 and 53 constituting the nonwoven webs 48, 52 and 54, respectively, by thermal point bonding but insufficient to either trigger shrinkage of nonwoven web 52 or to shrink the nonwoven web 52 by a level adequate to provide the desired raised areas 47 (FIGS. 4A and 4B). The laminate structure 56 is then conveyed at a normal production line speed past the through-air bonder 76. The through-air bonder 76 includes a conveyor 78 downstream from conveyors 46 (FIG. 1) having a perforated belt 80 upon which the laminate structure 56 is received and conveyed, a plenum 82 with a perforated surface 84, and a heat source 86 suspended above the perforated surface 84 and on an opposite side of the laminate structure 56 from perforated surface 84. The heat source 86 heats the air above the laminate structure 56 to a temperature sufficiently hot to cause shrinkage of nonwoven web 52, when nonwoven web 52 is exposed to the heated air. Specifically, the air is heated to a temperature in the range of about 100° C. to about 200° C. measured at the surface of the laminate structure 56. The air is forced through the laminate structure 56 by vacuum or suction applied to the interior of the plenum 82, as indicated by the arrows in FIG. 6. Pulling the air through the laminate structure 56 promotes rapid and even transmission of heat to nonwoven web 52 and triggers shrinkage of nonwoven web 52 relative to surrounding nonwoven webs 48 and 54. The shrinkage may be additive with any shrinkage resulting from calendering.

1. A spunbond laminate comprising:
a first nonwoven web including a first plurality of spunbond filaments characterized by a first thermoplastic polymer, said first thermoplastic polymer characterized by a spun crystallinity that is substantially equal to an initial crystallinity in a solid state before spinning to form said first plurality of filaments; and
a second nonwoven web including a second plurality of spunbond filaments characterized by a second thermoplastic polymer and laminated with said first nonwoven web to form a laminate structure, said second thermoplastic polymer characterized by a spun crystallinity that is less than an initial crystallinity in a solid state before spinning to form said second plurality of filaments,
wherein said first nonwoven web is bonded to said second nonwoven layer at a plurality of bonded areas and said first nonwoven layer includes a plurality of raised areas each bounded by bonded areas, said raised areas produced by causing said spun crystallinity of said second thermoplastic polymer to approach said initial crystallinity of said second thermoplastic polymer, after the second plurality of filaments are formed, and thereby shrinking said second nonwoven web relative to said first nonwoven web.

2. The spunbond laminate of claim 1 wherein said second thermoplastic polymer is polyethylene terephthalate.

3. The spunbond laminate of claim 2 wherein said first thermoplastic polymer is polypropylene.

4. The spunbond laminate of claim 1 further comprising:
a third nonwoven web formed from a third plurality of spunbond filaments comprising a third thermoplastic polymer and laminated on said second nonwoven web such that said second nonwoven web is positioned between said first nonwoven web and said third nonwoven web.

5. The spunbond laminate of claim 1 wherein said third nonwoven web is bonded to said second nonwoven layer at a plurality of bonded areas, and said third nonwoven layer has a plurality of raised areas each positioned between bonded areas.

6. The spunbond laminate of claim 4 wherein said third thermoplastic polymer is polypropylene.

7. The spunbond laminate of claim 1 wherein said plurality of bonded areas is characterized by a percent bond area of less than about 20 percent.

8. A method of forming a bloused laminate, comprising:
forming a first plurality of filaments from a molten first thermoplastic polymer characterized by an initial solid-state crystallinity;
attenuating the first plurality of filaments at a spinning speed effective to cause the first thermoplastic polymer to have a spun crystallinity approximately equal to the initial solid-state crystallinity;
collecting the first plurality of filaments to form a first nonwoven web;
forming a second plurality of filaments from a molten second thermoplastic polymer characterized by an initial solid-state crystallinity;
attenuating the second plurality of filaments at a spinning speed effective to cause the second thermoplastic polymer to have a spun crystallinity less than the initial solid-state crystallinity;
collecting the second plurality of filaments to form a second nonwoven web;
bonding the second nonwoven web and the first nonwoven web at a plurality of bonded areas; and
heating the first and second nonwoven webs to cause said spun crystallinity of said second thermoplastic polymer to approach said initial solid-state crystallinity of said second thermoplastic polymer, and thereby inducing a surface area of the second nonwoven web to shrink relative to a surface area of the first nonwoven web to form a plurality of raised areas in first nonwoven layer each bounded by bonded areas.

9. The method of claim 8 further comprising:
forming a third nonwoven web laminated on the second nonwoven web so that the second nonwoven web is interposed between the first and third nonwoven webs.

10. The method of claim 9 wherein forming the third nonwoven web further comprises:
forming a third plurality of filaments from a molten third thermoplastic polymer characterized by an initial solid-state crystallinity; and
attenuating the third plurality of filaments at a spinning speed effective to cause the third thermoplastic polymer to have a spun crystallinity approximately equal to the initial solid-state crystallinity.

11. The method of claim 9 wherein heating the first and second nonwoven webs further comprises:
heating the third nonwoven web so that a plurality of raised areas are formed in the third non-woven web when the surface area of the second nonwoven web shrinks relative to a surface area of the third nonwoven web, each raised area of said third non-woven web being positioned between bonded areas over which the third non-woven web is bonded to the second non-woven web.

12. The method of claim 8 wherein heating the first and the second nonwoven webs further comprises:
forcing heated air through the first and the second nonwoven webs.

13. The method of claim 8 wherein the first and the second nonwoven webs are heated simultaneously with the bonding, and heating the first and the second nonwoven webs further comprises:
transporting the first and the second nonwoven webs through a heated calender.

14. The method of claim 8 wherein the first nonwoven web is formed by a first spunbonding station and the second nonwoven web is formed by a second spunbonding station downstream of the first spunbonding station.

15. The method of claim 8 wherein heating the first and second nonwoven webs further comprises:
exposing the first and the second nonwoven webs to a heated environment having a temperature in the range of about 100° C. to about 200° C.

16. The method of claim 8 wherein said plurality of bonded areas is characterized by a percent bond area of less than about 20 percent.

17. The method of claim 8 wherein collecting the second plurality of filaments further comprises:
depositing the second nonwoven web on the first nonwoven web.
